(19) United States
(12) Patent Application Publication
(10) Pub. No.: US 2025/0386212 A1
(43) Pub. Date: Dec. 18, 2025

(54) DEVICE COORDINATED DYNAMIC CONFIGURATION MANAGEMENT FOR HIGH RELIABILITY COMMUNICATION

(71) Applicant: QUALCOMM Incorporated, San Diego, CA (US)

(72) Inventors: Alfred ASTERJADHI, San Diego, CA (US); Abhishek Pramod PATIL, San Diego, CA (US); Sai Yiu Duncan HO, San Diego, CA (US); Guido Robert FREDERIKS, Watsonville, CA (US); George CHERIAN, San Diego, CA (US); Gaurang NAIK, San Diego, CA (US); Sandip HOMCHAUDHURI, San Jose, CA (US); Naveen Kumar KAKANI, Flower Mound, TX (US)

(21) Appl. No.: 18/741,346

(22) Filed: Jun. 12, 2024

(51) Int. Cl. H04W 24/02; H04L 1/00

(52) U.S. Cl. CPC H04W 24/02; H04L 1/0003; H04L 1/0008

(57) ABSTRACT

This disclosure provides methods, components, devices and systems for device coordinated dynamic configuration management for high reliability communication. Some aspects more specifically relate to techniques to coordinate the transfer of data between primary and secondary memories of a device such as an access point (AP) for communication with a wireless station (STA). The AP may be capable of storing data in a directly accessible primary memory, and in a secondary memory, which may be inaccessible until the data in the secondary memory is transferred to the primary memory. In some aspects, the AP may dynamically transfer data based on changes in one or more operating modes of a STA. The AP may transfer data from the secondary memory to the primary memory in accordance with the STA entering an active mode, or from the primary memory to the secondary memory in accordance with the STA entering a power saving mode.

### TECHNICAL FIELD

This disclosure relates generally to wireless communication and, more specifically, to device coordinated dynamic configuration management for high reliability communication.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

Some WLANs may support ultra-high reliability (UHR) protocols for multiple AP (multi-AP) coordination, high signaling throughput, low latency communication, and reduced device level power consumption, among other aspects for wireless communication devices such as STAs, APs or UEs. Some UHR protocols also support resource management, data storage, and data signaling techniques for devices to increase efficiency for accessing and communicating data. The resource management, data storage, and data signaling techniques may relate to memory and information storage, various antenna configuration types for communicating data by the AP or other non-AP STAs, different radio frequency (RF) front end configurations implemented by the AP or by other non-AP STAs, different encoding configurations for data communicated by the AP or by other non-AP STAs, different processing times, different supported frequencies, different device modules, different central processing units (CPUs), among other resources or aspects of the AP or other non-AP STAs. For example, a device such as an AP or a STA may be configured to store data in different storage locations (such as different memories). For example, a first memory of the AP or STA may be part of a computing component of the AP or STA that is responsible for storing data that is currently in use by the AP, or data that is actively communicated between the AP and associated STAs, between the STA and an AP, between STAs, or between APs. In some aspects, the first memory may be relatively more limited in storage capability, and relatively more promptly accessible, and may be relatively more costly than a secondary memory of the AP or the STA, which may function as a persistent storage location for data that the AP or STA accesses less frequently than data stored in the first memory. For example, an AP may store, move, or transfer data between the first memory and the second memory based on various factors such as based on polling requests received from associated STAs or based on total network traffic. The AP, however, may lack an ability to effectively manage and coordinate the transfer of data between the first and second memories with associated STAs, which may result in inefficient memory usage for the AP and incur increased communication latency for the associated STAs. Additionally or alternatively, the AP may lack an ability to efficiently implement different antenna configurations, RF front end configurations, encoding techniques, different processing times, different supported frequencies, different device modules, different CPUs, among other resources or aspects of the AP or other non-AP STAs, which may limit signaling accuracy and throughput, among other challenges.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a device such as a wireless access point (AP). The device may include a processing system that includes processor circuitry and memory circuitry that stores code. The processing system may be configured to cause the device to communicate with a station (STA) that is operating in a first mode, using a primary configuration of the device in accordance with the STA operating in the first mode, change at least a portion of first data associated with the STA from being associated with the primary configuration of the device to being associated with a secondary configuration of the device in accordance with a change in operating mode of the STA from the first mode to a second mode, change at least the portion of the first data associated with the STA from being associated with the secondary configuration of the device to being associated with the primary configuration of the device in accordance with a change in operating mode of the STA from the second mode back to the first mode, and communicate with the STA using the primary configuration of the device in accordance with the changing of at least the portion of the first data from being associated with the secondary configuration of the device to being associated with the primary configuration of the device and in accordance with the STA operating in the first mode.

Another innovative aspect of the subject matter described in this disclosure can be implemented in a method for wireless communication by or at a device such as a wireless AP. The method may include communicating with a STA that is operating in a first mode, using a primary configuration of the device in accordance with the STA operating in the first mode, changing at least a portion of first data associated with the STA from being associated with the primary configuration of the device to being associated with a secondary configuration of the device in accordance with a change in operating mode of the STA from the first mode to a second mode, changing at least the portion of the first data associated with the STA from being associated with the secondary configuration of the device to being associated with the primary configuration of the device in accordance with a change in operating mode of the STA from the second mode back to the first mode, and communicating with the STA using the primary configuration of the device in accordance with the changing of at least the portion of the first data from being associated with the secondary configuration of the device to being associated with the primary configuration of the device and in accordance with the STA operating in the first mode.

Another innovative aspect of the subject matter described in this disclosure can be implemented in a device such as a wireless AP. The device may include means for communicating with a STA that is operating in a first mode, using a primary configuration of the device in accordance with the STA operating in the first mode, means for changing at least a portion of first data associated with the STA from being associated with the primary configuration of the device to being associated with a secondary configuration of the device in accordance with a change in operating mode of the STA from the first mode to a second mode, means for changing at least the portion of the first data associated with the STA from being associated with the secondary configuration of the device to being associated with the primary configuration of the device in accordance with a change in operating mode of the STA from the second mode back to the first mode, and means for communicating with the STA using the primary configuration of the device in accordance with the changing of at least the portion of the first data from being associated with the secondary configuration of the device to being associated with the primary configuration of the device and in accordance with the STA operating in the first mode.

Another innovative aspect of the subject matter described in this disclosure can be implemented in a non-transitory computer-readable medium storing code for wireless communication by or at a device such as a wireless AP. The code may include instructions executable by one or more processors to communicate with a STA that is operating in a first mode, using a primary configuration of the device in accordance with the STA operating in the first mode, change at least a portion of first data associated with the STA from being associated with the primary configuration of the device to being associated with a secondary configuration of the device in accordance with a change in operating mode of the STA from the first mode to a second mode, change at least the portion of the first data associated with the STA from being associated with the secondary configuration of the device to being associated with the primary configuration of the device in accordance with a change in operating mode of the STA from the second mode back to the first mode, and communicate with the STA using the primary configuration of the device in accordance with the changing of at least the portion of the first data from being associated with the secondary configuration of the device to being associated with the primary configuration of the device and in accordance with the STA operating in the first mode.

Some examples of the method, devices, and non-transitory computer-readable medium described herein may further include operations, features, means, or instructions for receiving, from the STA, one or more polling messages indicative of the change in operating mode of the STA from the second mode back to the first mode, where changing at least a portion of the first data associated with the STA from being associated with the secondary configuration of the device to being associated with the primary configuration of the device may be in accordance with receiving the one or more polling messages.

Some examples of the method, devices, and non-transitory computer-readable medium described herein may further include operations, features, means, or instructions for transmitting, to the STA, one or more messages indicative of a duration of time the device uses to change at least the portion of the first data associated with the STA from being associated with the secondary configuration of the device to being associated with the primary configuration of the device.

Some examples of the method, devices, and non-transitory computer-readable medium described herein may further include operations, features, means, or instructions for communicating a first frame to initiate a service duration for communication of at least the portion of the first data between the device and the STA, where changing at least the portion of the first data associated with the STA from being associated with the secondary configuration of the device to being associated with the primary configuration of the device includes transmitting, to the STA, an indication of a duration of time the device uses to change at least the portion of the first data from being associated with the secondary configuration of the device to being associated with the primary configuration of the device, and communicating the portion of the first data includes communicating, via a protected control frame, at least the portion of the first data associated with the STA in accordance with initiation of the service duration and the STA operating in the first mode.

In some examples of the method, devices, and non-transitory computer-readable medium described herein, the primary configuration of the device and the secondary configuration of the device may be each associated with at least one of a first quantity of antennas and a second quantity of antennas, a first quantity of receiver front ends and a second quantity of receiver front ends, a first modulation and coding scheme (MCS) and a second MCS, a first central processing unit (CPU) configuration and a second CPU configuration, or a first encoder type and a second encoder type.

Another innovative aspect of the subject matter described in this disclosure can be implemented in a STA. The STA may include a processing system that includes processor circuitry and memory circuitry that stores code. The processing system may be configured to cause the STA to switch from a second mode of the STA to a first mode of the STA, communicate, during operation in the first mode of the STA, one or more polling messages to initiate a service duration with a device, and receive, from the device, data associated with the STA in accordance with the data changing from being associated with a secondary configuration of the device to being associated with a primary configuration of the device and in accordance with the STA switching from the second mode of the STA to the first mode of the STA.

Another innovative aspect of the subject matter described in this disclosure can be implemented in a method for wireless communication by or at a STA. The method may include switching from a second mode of the STA to a first mode of the STA, communicating, during operation in the first mode of the STA, one or more polling messages to initiate a service duration with a device, and receiving, from the device, data associated with the STA in accordance with the data changing from being associated with a secondary configuration of the device to being associated with a primary configuration of the device and in accordance with the STA switching from the second mode of the STA to the first mode of the STA.

Another innovative aspect of the subject matter described in this disclosure can be implemented in a STA. The STA may include means for switching from a second mode of the STA to a first mode of the STA, means for communicating, during operation in the first mode of the STA, one or more polling messages to initiate a service duration with a device, and means for receiving, from the device, data associated with the STA in accordance with the data changing from being associated with a secondary configuration of the device to being associated with a primary configuration of the device and in accordance with the STA switching from the second mode of the STA to the first mode of the STA.

Another innovative aspect of the subject matter described in this disclosure can be implemented in a non-transitory computer-readable medium storing code for wireless communication by or at a STA. The code may include instructions executable by one or more processors to switch from a second mode of the STA to a first mode of the STA, communicate, during operation in the first mode of the STA, one or more polling messages to initiate a service duration with a device, and receive, from the device, data associated with the STA in accordance with the data changing from being associated with a secondary configuration of the device to being associated with a primary configuration of the device and in accordance with the STA switching from the second mode of the STA to the first mode of the STA.

Some examples of the method, STAs, and non-transitory computer-readable medium described herein may further include operations, features, means, or instructions for receiving, from the device, one or more messages indicative of a duration of time the device uses to change the data from being associated with the primary configuration of the device to being associated with the secondary configuration of the device, where the duration of time the device uses change the data from being associated with the primary configuration of the device to being associated with the secondary configuration of the device includes a request for padding to be applied to messages communicated by the STA to the device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows an example of a signaling diagram that supports device coordinated dynamic configuration management for high reliability communication.

FIG. 4 shows an example of a process flow that supports device coordinated dynamic configuration management for high reliability communication.

FIG. 5 shows a block diagram of an example wireless communication device that supports device coordinated dynamic configuration management for high reliability communication.

FIG. 6 shows a block diagram of an example wireless communication device that supports device coordinated dynamic configuration management for high reliability communication.

FIG. 7 shows a flowchart illustrating an example process performable by or at an access point (AP) that supports device coordinated dynamic configuration management for high reliability communication.

FIG. 8 shows a flowchart illustrating an example process performable by or at a station (STA) that supports device coordinated dynamic configuration management for high reliability communication.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks may support various techniques to comply with ultra-high reliability (UHR) communication standards, including techniques that implement device-coordinated resource management for storage and communication of data between wireless communication devices. For example, an access point (AP) may operate in accordance with a primary configuration or a secondary configuration, and may switch between the primary and secondary configurations based on different network or device-specific factors. In some implementations, for example, the primary configuration of the AP or STA may correspond to a primary memory in which the AP or STA stores more frequently accessed data, and the secondary configuration of the AP or STA may correspond to a secondary memory in which the AP or STA stores less frequently accessed data. For example, the AP or STA may transfer data from the secondary memory to the primary memory prior to transmitting the data to a receiving device (such as a receiving STA or AP). In some other implementations, the primary and secondary configurations of the AP or STA may correspond to different antenna configurations of the AP, different radio frequency (RF) front end configurations of the AP, different encoding configurations implemented by the AP, different central processing unit (CPU) configurations, different processing times, different supported frequencies, among other possible configurations of the AP or STA. In some examples, such as in a high traffic setting with multiple STAs served by the AP, the AP may store at least some of the data for the STAs in the secondary memory, or may communicate with the STAs in accordance with either the primary or secondary configuration of the AP (for example, including different antenna configurations, different RF front end configurations, different encoding configurations, different CPU configurations, different processing times, different supported frequencies, etc.). In some aspects, however, a STA may poll for the data that is located in the secondary memory of the AP (or may poll for data in accordance with a secondary configuration of the AP), and the STA may wait for a duration as the AP transfers the polled data from the secondary memory to the primary memory (or for the AP to switch between the primary and secondary configurations of the AP). In some aspects, the STA may trigger the AP to transition from one first configuration to a second configuration. This waiting time may increase signaling latency between the AP and the STA, and may be relatively inefficient for UHR scenarios.

Various aspects relate generally to one or more device-coordinated configuration management techniques that may be implemented by APs and/or wireless communication devices, such as wireless stations (STAs), to coordinate the efficient storage, access, and/or communication of data. Some aspects more specifically relate to how an AP (or a non-AP STA) may store data associated with a STA in either a primary memory or a secondary memory, and may dynamically transfer data between the primary and secondary memories based on various different STA or network-based factors. Some other aspects may relate to how an AP or STA may switch between different AP or STA configurations to effectively transmit or encode data. In some aspects, a wireless communication network may support dynamic resource management techniques to allow efficient data storage and communication for wireless devices. In some examples, an AP may dynamically move data between primary and secondary memories of the AP (or may communicate data in accordance with a primary and secondary configurations of the AP) based on an operational mode of a STA served by the AP (or switches between operational modes of the STA). For example, the AP may transfer the data associated with the STA to the primary memory (or the AP may switch between primary and secondary configurations) based on the STA operating in an active mode, and may move the data associated with the STA to the secondary memory based on the STA operating in a power saving mode, and may switch between primary and secondary memory storage based on changes between active and power saving mode changes of the STA. In such implementations, the AP may access the data in the primary memory for durations that the STA is active, and may conserve memory resources in the primary memory for durations that the STA is inactive. In some other implementations, the AP may move data for different STAs from the primary memory to the secondary memory (or from the secondary memory to the primary memory) based on traffic predictions for the STAs. For example, if the AP predicts that a STA will experience a duration of high traffic for a duration, the AP may preemptively move the data for the STA from the secondary memory to the primary memory. In some other implementations, the AP or STA may support signaling to coordinate the data storage between the primary and secondary memories or signaling to coordinate switching between primary and secondary AP or STA configurations. For example, the AP may send one or more messages to the STAs that indicate an amount of time that the AP uses to transfer data from the secondary memory to the primary memory (or an amount of time that the AP uses to switch between the primary and secondary configurations), so that the STAs can effectively coordinate active or power saving operation times accordingly, and/or so that the STAs can pad uplink transmissions to accommodate the data transfer time indicated by the AP.

Particular aspects of the subject matter described in this disclosure can be implemented to realize one or more of the following potential advantages. In some examples, by coordinating the association of data between the primary and secondary configuration, such as memories, of the AP in accordance with different operational mode changes of the STA, the described techniques can be used to reduce the latency of communication between the AP and the STA. For example, the AP may load data in a primary memory in accordance with the STA transitioning to an active state so that the data is ready for transmission at the primary memory once the STA polls for the data. Further, by leveraging knowledge of the operational mode changes of the STA, the AP may be able to more efficiently allocate memory resources and implement different signaling techniques associated with primary and secondary AP configurations, such as primary and secondary AP memories. Additionally, coordinating the movement of data between primary and secondary memories of the AP and communication with the STA regarding the movement of data (or otherwise changing the data from being associated with the primary and secondary configurations of the AP) may reduce device-level power consumption since the STA is made aware of the location of data or a current configuration of the AP so the STA may remain in an inactive or power saving mode for a longer duration instead of waiting in an active state for the transfer of data between the primary and secondary memories of the AP, or for a switch between AP configurations. Additionally, the coordination of data association between primary and secondary configurations of the AP may result in more fully realized capability and performance and fewer communication errors, and the described techniques also may further support higher data rates, greater spectral efficiency, improved user experience, and greater system capacity, among other benefits.

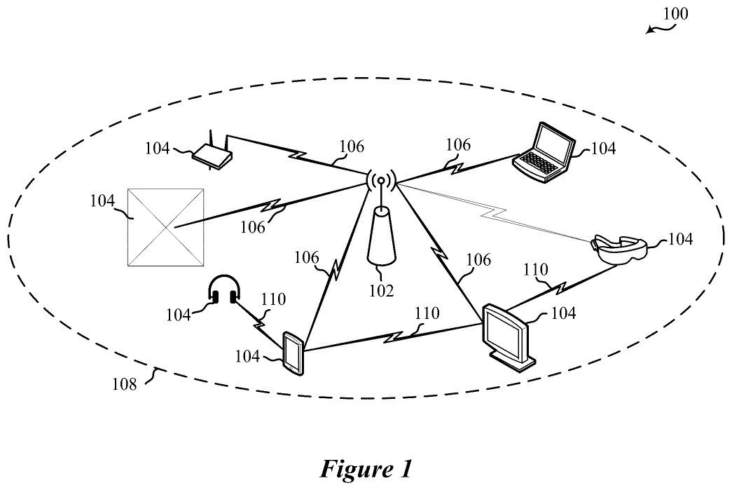

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (cNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless carbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while an UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

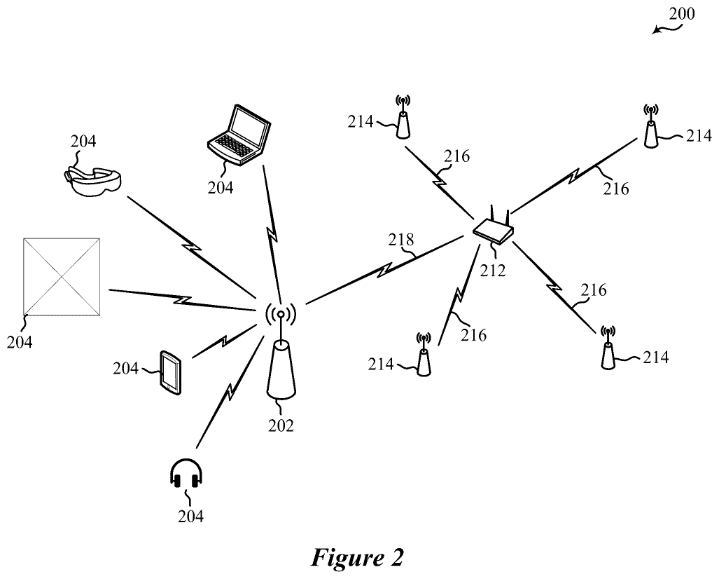

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 202, STAs 204, or both. The wireless communication devices 214 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (such as cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

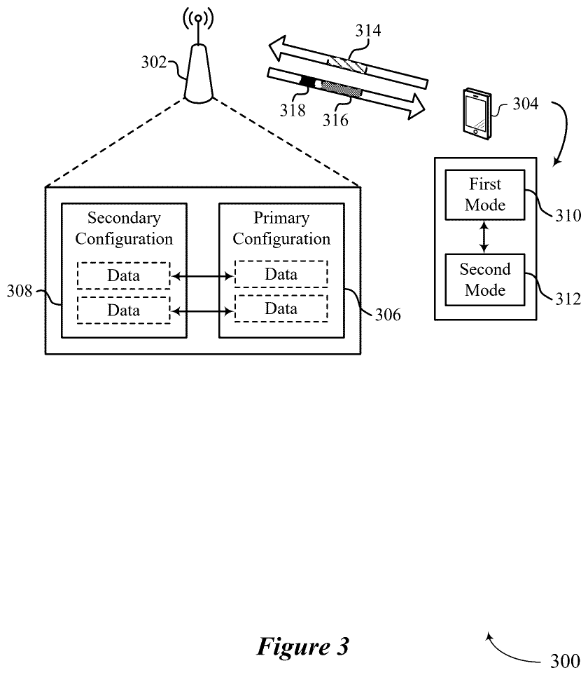

FIG. 3 shows an example of a signaling diagram 300 that supports device coordinated dynamic configuration management for high reliability communication. The signaling diagram 300 may implement or be implemented to realize one or more aspects of the wireless communication network 100, or the wireless communication network 200. For example, the signaling diagram 300 illustrates communication between an AP 302 (or another device) and a STA 304, each of which may be examples of corresponding devices described with reference to the wireless communication network 100, or the wireless communication network 200.

Some systems may implement ultra-high reliability (UHR) protocols to support multiple AP (multi-AP) coordination and communication. For example, multi-AP coordination and may allow for multiple independent APs (such as a first AP and at least a second AP) to coordinate various transmission parameters with each another. For example, the multiple independent APs may coordinate parameters relating to operating frequency, transmission schedule, transmit power, among other parameters, so that signaling/frame exchanges from and for the multiple independent APs do not interfere with each other. For example, in a coordinated time domain multiple access (CTDMA) scheme, an AP (such as the AP 302) may schedule, in a BSS associated with the AP, signals that are non-overlapping with communication in BSSs associated with other APs. In some implementations, for example, in a coordinated orthogonal frequency domain multiple access (COFDMA), signals in two or more BSS may overlap in time but may be non-overlapping in frequency. In some other implementations, for example, in a coordinated spatial reuse (CSR), the signals in two or more BSSs may overlap in both time and frequency, and each AP may control an associated transmit power such that the interference experienced by a receiving STA is smaller than a packet error threshold.

UHR protocols may support low latency signaling between APs and STAs (such as the AP 302 and the STA 304), including reduced latency related to AP response time. For example, the STA 304 (which may be an example of a non-AP STA) may transmit one or more PPDUs (such as one or more power-saving (PS) polling frames) to the AP 302 to request data from the AP 302, and the AP 302 may generate and transmit one or more protected control frames in response to the one or more PPDUs, which includes the requested data. The one or more protected control frames may be secured data frames subject to one or more encryption or privacy protection protocols to enable secure data communication. Additionally, or alternatively, multi-AP communication may support operations over multiple links to increase throughput by assigning low latency traffic to links with corresponding low latency. In some aspects, an AP 302 may be capable of performing advanced beamforming techniques such as coordinated beamforming (CBF) or joint transmission and reception (JTR). In some examples, an AP 302 may generate pending downlink buffer units (BUs) in response to polling frames from one or more STAs including at least the STA 304, and may communicate the downlink BUs to other APs associated with the one or more STAs, so that the other APs may load the downlink BUs so that a STA 304 that is roaming between the AP 302 and the other APs may receive the downlink BUs without excess latency.

In some implementations, to increase the reliability and to reduce the latency of communication between the AP 302 and one or more STAs (including at least the STA 304), the AP 302 (or the STA 304, or one or more other devices) may perform different forms of resource management, and may switch between different configurations of the AP 302 to support UHR communication. In some aspects, the AP 302 may be capable of operating in accordance with a primary configuration 306 and a secondary configuration 308. For example, the AP 302 may store data (for example, pending data addressed to the STA 304 or one or more configuration parameters that enable frame exchanges between the AP 302 and the STA 304) in accordance with the primary configuration 306 and the secondary configuration 308, or may communicate in accordance with a primary configuration of antennas and a secondary configuration of antennas, or may communicate via a primary RF front end configuration and a secondary RF front end configuration, or may communicate using a primary encoding configuration and a secondary encoding configurations, or may process information using a primary CPU configuration and a secondary CPU configuration, among other possible primary and secondary configurations of the AP 302.

In some implementations, the AP 302 may store data and other parameters (such as scheduling information, block acknowledgement (BA) session information, and other STA information) for a STA 304 in accordance with a primary configuration 306 of the AP (such as in a primary memory of the AP 302) or in accordance with a secondary configuration of the AP 302 (such as in a secondary memory of the AP 302). For example, the primary configuration 306 of the AP may be associated with one or more key performance indicators (KPIs) that is improved relative to a corresponding one or more KPIs associated with the secondary configuration of the AP 302 (the one or more KPIs being associated with latency of data retrieval, cost, power consumption, data rate, speed of data access, among other performance metrics). In some other examples, the primary memory may be associated with a hardware cache of the AP 302 and the secondary memory of the AP 302 may be associated with a double data rate (DDR) memory of the AP.

In some such implementations that the AP 302 serves multiple STAs, the AP 302 may store at least some of the data for the STAs in a secondary memory of the AP 302 to reduce storage burden for the primary memory. The AP 302, however, may be unable to directly access data stored in the secondary memory for transmission to the STA 304, and may instead transfer data from the secondary memory to the primary memory for transmission to a STA 304. For example, in implementations that a STA 304 sends a polling message that requests data from the AP 302 that is stored in the secondary memory, the AP 302 may transfer the data from the secondary memory to the primary memory before transmitting the data to the STA 304. In some such examples, the STA 304 may experience increased latency for receiving data that is stored in the secondary memory (relative to data that is stored in the primary memory).

The AP 302 may store various data and parameters associated with a STA 304 in the primary memory, the secondary memory, or both. For example, the AP 302 may store different security parameters for the STA 304, pairwise temporal keys (PTKs) or other data encryption parameters for the STA 304, packet numbers, transmission and reception parameters for the STA 304, lists of relay nodes from a source of the STA 304 to the destination of the STA 304 in a multi-hop scenario, downlink BUs, reorder buffers for uplink data, block acknowledgment (BA) sessions and/or scoreboards, among other data and parameters available to the STA 304. In some implementations, the AP 302 may store data and parameters in the primary memory so that the AP 302 can promptly access the data and parameters in response to polling by the STA 304. In some such implementations, however, the AP 302 may be unable to store all of the data for each STA in primary memory due to storage and cost restrictions of the primary memory, and may store at least a portion of the data in the secondary memory.

In order to provide low-latency UHR communication with STAs, the AP 302 may support dynamic resource management techniques to efficiently manage switching between the primary configuration 306 and secondary configuration 308 of the AP. For example, the dynamic resource management may manage the transfer of data between the primary and secondary memories of the AP 302, the switching between primary and secondary antenna configurations, the switching between primary and secondary RF front end configurations, and/or the switching between primary and secondary encoding schemes. The AP may perform dynamic resource management techniques based on the fulfillment of various criteria. For example, the AP 302 may transfer data between the primary memory and the secondary memory (or between the secondary memory and the primary memory) based on a quantity of STAs associated with the AP 302 (such as the AP 302 may transfer at least a portion of data to the secondary memory in examples in which the quantity of STAs associated with the AP 302 exceeds a threshold, or the amount of data stored at the primary memory exceeds a threshold), based on different traffic patterns for STAs associated with the AP 302 (such as the AP 302 may predict or otherwise determine durations of high traffic for associated STAs, and may transfer associated data from the secondary memory to the primary memory for access during the durations of high traffic).

In some implementations, the AP 302 may perform dynamic resource management based on different power management modes of the STAs associated with the AP 302. For example, in implementations that the STA 304 is operating in an active mode (such as a first mode 310), the AP 302 may store data for the STA 304 in the primary memory, and in implementations that the STA 304 is operating in an inactive or power saving mode (such as a second mode 312), the AP 302 may store the data for the STA 304 in the secondary memory. In some examples, the AP 302 may transfer data associated with the STA 304 from the secondary memory to the primary memory once the STA 304 transitions from an inactive or power saving mode to an active mode. For example, the AP 302 may transfer data for the STA 304 from the secondary memory to the primary memory at scheduled target wakeup times (TWTs) for the STA 304, so that the data for the STA 304 is located in the primary memory for durations in which the STA 304 transitions from an inactive or power saving mode to an active mode. Additionally, or alternatively, the STA 304 may transmit one or more polling frames 314 (such as at least one of a power-saving (PS) poll frame, an unscheduled power save delivery (APSD) trigger, a control frame sent from the STA 304 to the AP 302, among other polling frame types), and the AP 302 may transfer the data for the STA 304 from the secondary memory to the primary memory after receiving the one or more polling frames 314. In some aspects, the reactivity of the AP 302 to the one or more polling frames (such as a duration that the AP 302 uses to transmit the requested data to the STA 304) may be based on the stored location of the data. For example, the reactivity of the AP 302 may be relatively faster for examples in which the data requested by the STA 304 is stored in the primary memory, and the reactivity of the AP 302 may be relatively slower for examples in which the data requested by the STA 304 is stored in the secondary memory. In some embodiments the STA 304 may indicate in which configuration it expects the AP 302 to be in, in the transmitted frame, and in some examples, the STA 304 may also indicate the duration of time for which this configuration to be valid.

Additionally, or alternatively, the AP 302 may implement dynamic resource management to efficiently utilize available memory at the AP 302 and to increase the effectiveness of frame exchanges with associated STAs. For example, the AP 302 may move associated data and parameters for STAs that are inactive to the secondary memory, and may move associated data and parameters for STAs that are active or expected to become active into the primary memory. For example, the AP 302 may predict whether a STA will become active based on whether communication with the STA 304 is periodic (such as for examples that the STA 304 communicates data during portions of a periodic interval, the AP 302 may predict the STA 304 will be active during some portions of the periodic interval, and inactive during other portions of the periodic interval), and may move data associated with the STA 304 to the primary memory during active times of the STA 304. In some implementations, the AP 302 may determine one or more durations in which data is concentrated for the STA 304, and may move data from the secondary memory to the primary memory prior to the one or more durations of concentrated data. In some examples, the AP 302 may implement one or more machine learning or artificial intelligence (AI) modes to predict durations that the one or more STAs will be active, and the AP 302 may move dedicate memory in the primary memory for times that the STA 304 is expected to be active. In some such examples, the AP may train the one or more machine learning or AI models using an activity or signaling history (or other behavioral history) associated with the STA 304.

In some implementations, the AP 302 may communicate, with the STA 304, an indication 316 (such as an explicit indication or an implicit indication) of a location in which the AP 302 has stored data associated with the STA 304 (such as all of the data associated with the STA 304 or at least a portion of the data associated with the STA 304). For example, the AP 302 may indicate that the data (or at least a portion of the data) associated with the STA 304 is stored in either the primary memory or the secondary memory. In such implementations, the STA 304 may use the indication of the location of the data to coordinate wake up times for the STA 304. For example, the STA 304 may coordinate wake up times such that the STA 304 wakes up at times that the AP 302 has data associated with the STA 304 stored in the primary memory, and may remain in a power saving mode in which data associated with the STA 304 stored in the secondary memory. The coordination of wake up times for the STA 304 may reduce the amount of time that the STA 304 waits to receive data from the AP 302, since the data may be already located in the primary memory.

The AP 302 may communicate indications of the location of the data associated with the STA 304 using different management frames (such as beacon frames). In some examples, the AP 302 may transmit the indication 316 as a traffic indication map (TIM) element that includes a TIM bit that is indicative of whether the data associated with the STA 304 is located in the primary memory of the AP 302 or in the secondary memory of the AP 302. For example, the TIM bit may have a value of “0” or “1,” and a TIM bit having a value of “1” may indicate that the AP 302 has pending downlink buffered data for the STA 304, and that the data associated with the STA is located in the primary memory of the AP 302. Additionally, or alternatively, a TIM bit having a value of “0” may indicate that the AP 302 lacks pending downlink buffered data for the STA 304, and that the data associated with the STA 304 is located in the secondary memory of the AP 302. In some examples, the AP 302 may store data for the STA 304 in the secondary memory of the AP 302 by default until an exchange period or a service period is initiated between the STA 304 and the AP 302. For example, the STA 304 may initiate the service period by transmitting an unscheduled automatic power save delivery (UAPSD) trigger to the AP 302 (or another control frame or trigger), and in response to the trigger, the AP 302 may move the data associated with the STA 304 from the secondary memory to the primary memory of the AP 302, and may transmit the data 318 to the STA 304. Additionally, or alternatively, the AP 302 may initiate the service period by transmitting a downlink frame, and may move data associated with the STA 304 from the secondary memory of the AP 302 to the primary memory of the AP based on transmission of the downlink frame.

In some implementations that the STA 304 initiates the service period with the AP 302, after the STA 304 transmits an initiation trigger, the AP 302 may respond to the trigger by transmitting an acknowledgment message. In some examples, the AP 302 may transmit the acknowledgment message in an unprotected frame which is indicative of an amount of time the AP 302 will use to transfer the data from the secondary memory to the primary memory. The STA 304 may communicate with the AP 302 after the amount of time elapses until the termination of the service period (such as until the AP 302 transmits a frame that indicates an end of the service period, or a trigger for the STA 304 to go to sleep or transition to a power save mode).

In some examples, the AP 302 may store data for STAs in either the primary memory or the secondary memory based on a current power management modes for the STAs. For example, the AP 302 may store data for STAs operating in an active mode in the primary memory of the AP 302, and may store data for STAs operating in an inactive or power save mode in the secondary memory of the AP 302. Additionally, or alternatively, the AP 302 may store data for STAs operating in a dynamic power saving mode in the primary memory of the AP 302. For example, a STA that operates in a dynamic power saving mode may listen for control frames using a 20 MHz radio, and may transition to a 160 MHz radio after receiving a control frame from the AP 302. The AP 302 may anticipate the transition to active mode for the STAs in dynamic power save mode to occur relatively faster than STAs in other power saving modes, so the AP 302 may treat the STAs in dynamic power saving mode as though the STAs are in an active mode, and may store the data for the STAs in the primary memory of the AP 302.

In some implementations, the AP 302 may communicate an indication of a duration for the AP 302 to transfer the data associated with the STA 304 from the secondary memory to the primary memory. For example, the AP 302 may transmit a message to the STA 304 that indicates that the AP 302 will use a duration (such as 5 ms) to load data from the secondary memory to the primary memory. The STA 304 may then coordinate so that the STA 304 may remain in a power saving mode for the duration that the AP 302 uses to load the data to the primary memory. In some examples, the AP 302 may communicate an indication of whether the data associated with the STA 304 is in the primary memory of the AP 302 or in the secondary memory of the AP 302. In some examples that the AP 302 communicates that the data associated with the STA 304 is in the secondary memory of the AP 302, the AP 302 may transmit (such as with the indication of the location of the data or in another message) a request for the STA 304 to add padding to at least an initiating frame that the STA 304 transmits to the AP 302 to initiate a service period (and to request that the AP 302 transfers data associated with the STA 304 from the secondary memory to the primary memory). The AP 302 may confirm or deny the request/indication provided in the initiating frame. In some aspects, the AP 302 may request different amounts of padding for the STA 304 to add to the initiating frame based on different factors. In some examples, the AP 302 may request a limited amount of padding (such as primary padding), or no padding at all, in examples in which the AP 302 indicates that the data for the STA 304 is located in the primary memory of the AP 302. Additionally, or alternatively, the AP 302 may request additional padding (such as secondary padding) in examples in which the AP 302 indicates that the data for the STA 304 is located in the secondary memory. In some such examples, the amount of padding that the AP 302 requests may be associated with (proportional to, related to) an amount of time that the AP 302 uses to transfer data associated with the STA 304 from the secondary memory to the primary memory. In some examples, the AP 302 may transmit an acknowledgment message in which the data associated with the STA 304 is ready in the primary memory.

In some implementations, the STA 304 may communicate an initiating frame for functionalities of the AP 302 that may tolerate higher latency memory access. For example, the STA 304 may refrain from requesting frames that are associated with a primary memory access time that is less than a threshold access time (such as retrieval of downlink BUs, PTKs, among other frames). In some examples, the AP 302 may indicate a threshold amount of time (such as X amount of time) that passes prior to data being available in the primary memory of the AP 302. In such examples, the AP 302 may indicate (or configure) the threshold amount of time via a management (MGMT) frame or in a control response frame.

In some implementations, the AP 302 may communicate an indication of different sets of resources that may be available to different sets of STAs at different times. In some implementations, the AP 302 may communicate an indication of a current traffic load or BSS load at the AP 302. In some aspects in which the STA 304 determines that the BSS load indicated by the AP 302 is below a BSS load threshold, the STA 304 may determine that the AP 302 is operating with all data stored in the primary memory, and in examples that the BSS load is above the BSS load threshold, the STA 304 may determine that its data may be stored in the secondary memory of the AP 302. Additionally, or alternatively, the AP 302 may transmit, in a beacon frame, an indication of a counter which indicates how many STAs the AP 302 serves, and in examples in which the total quantity of STAs that the AP 302 serves is below a threshold quantity, the STA 304 may determine that the AP 302 stores data associated with the STA 304 in the primary memory of the AP 302.

In some implementations, the STA 304 may trigger the availability of data at the primary memory of multiple APs (for multiple links) including the AP 302 using different cross link management techniques. For example, the STA 304 may transmit a request (such as a single request) to the AP 302 to make data associated with the STA 304 available for at least one other AP. The AP 302 may communicate with at least the one other AP to trigger the availability of the data associated with the STA 304 at the other AP. In some such examples, the STA 304 may roam between different APs and may access data without transmitting multiple requests.

In some examples, the STA 304 may transmit a request for data to the AP 302 using a first capability or configuration of the STA 304, and may switch to a second capability. For example, the STA 304 may initially send packets with additional padding for a time that the AP 302 uses to transfer data associated with the STA 304 from the secondary memory to the primary memory, after the time elapses, the STA 304 may send packets without padding. In some other examples, the STA 304 may be capable of communicating using different MCSs. In some such examples, the STA 304 may initially send packets using a lower MCS, and may switch to using a higher MCS after the AP 302 adjusts to a higher MCS. In some other examples, the STA 304 may initially send packets via a first bandwidth (such as a relatively smaller bandwidth) and may switch to a second relatively larger bandwidth over time.

In some implementations, the AP 302 may assign different link statuses to communication links for different STAs. For example, the AP 302 may assign a link as being associated with a “link active” status or a “link idle” status based on a time indicated by a BSS timeout parameter (for example a 5 second BSS timeout parameter). In some aspects, the AP 302 may assign the “link active” status to a link that is currently experiencing traffic (or that has experienced traffic at a time less than the time indicated by the BSS timeout parameter), and may assign the “link idle” status to a link that lacks traffic for longer than the time indicated by the BSS timeout parameter. In some examples in which the last transmission of the STA 304 exceeds the time indicated by the BSS timeout parameter, the AP 302 may declare the link associated with the STA 304 as “inactive,” and the STA 304 may re-initiate a service period before communicating with the AP 302. In some examples, the AP 302 may transmit an indication of link statuses for the STAs served by the AP 302. For example, the STA 304 may receive an indication that the AP 302 is treating a link associated with the STA 304 as either “active” or “inactive,” so that the STA 304 may either continue communication with the AP 302 (in examples in which the link is declared “active” by the AP 302) or may initiate a service period with the AP 302 (in examples in which the link is declared “inactive” by the AP 302).

In some implementations, the primary configuration of the AP 302 and the secondary configuration of the AP 302 may not be limited to a primary memory of the AP 302 and a secondary memory of the AP 302. For example, the primary configuration of the AP 302 may correspond to a primary antenna configuration and the secondary configuration of the AP 302 may correspond to a secondary antenna configuration. For example, the AP 302 may switch between the primary and secondary antenna configurations based on various factors of the STA 304 (such as whether the STA 304 is in an active mode or a power saving mode, based on different capabilities of the STAs, based on a quantity or type of data signaled to the STA 304, among other factors described herein). Additionally, or alternatively, the primary configuration of the AP 302 may be a primary receiver front end configuration and the secondary configuration of the AP 302 may be a secondary receiver front end configuration. For example, the AP 302 may switch between different receiver front end configurations based on various factors of the STA 304 (such as the AP 302 may switch between a receiving configuration of 160 MHz and 20 MHz based on different capabilities of configurations of the STA 304, or based on other factors described herein). Additionally, or alternatively, the primary configuration of the AP 302 may be a primary MCS or LDPC, use of space time block code (STBC), PPDU formats, bandwidth (BW), network slice selection (NSS), encoding configuration and the secondary configuration of the AP 302 may be a secondary MCS or LDPC encoding configuration that the AP 302 may switch between based on different capabilities or configurations of the STA 304, or based on other factors described herein.

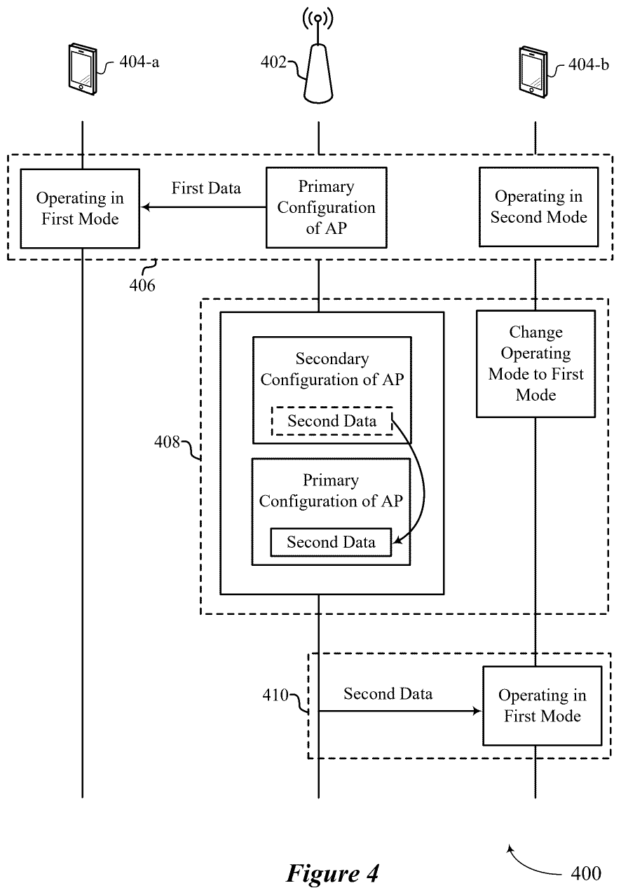

FIG. 4 shows an example of a process flow 400 that supports device coordinated dynamic configuration management for high reliability communication. The process flow 400 may implement or be implemented to realize one or more aspects of the wireless communication network 100, the wireless communication network 200, or the signaling diagram 300. For example, the process flow 400 illustrates communication between an AP 402 (or another device), a first STA 404-a, and a second STA 404-b, which may be examples of APs and STAs, or any other wireless communication devices, as illustrated by and described with reference to FIGS. 1-3.

In the following description of process flow 400, the operations between the AP 402, the first STA 404-a, and the second STA 404-b may be performed in a different order than the order shown, or other operations may be added or removed from the process flow 400. For example, some operations also may be left out of process flow 400, or may be performed in different orders or at different times. Further, although some operations or signaling may be shown to occur at different times for discussion purposes, these operations may actually occur at the same time. Although the AP 402, the first STA 404-a, and the second STA 404-b are shown performing the operations of process flow 400, some aspects of some operations also may be performed by one or more other wireless communication devices.

At 406, the AP 402 may communicate first data associated with the first STA 404-a, the first data being associated with a primary configuration of the AP 402. In some aspects, the AP 402 may communicate the first data in accordance with the primary configuration in accordance with the first STA 404-a operating in a first mode (such as an active mode of the first STA 404-a).

At 408, the AP 402 may change at least a portion of second data associated with a second STA 404-b from being associated with a secondary configuration of the AP 402 to being associated with the primary configuration of the AP 402 in accordance with a change in operating mode of the second STA 404-b from a second mode to the first mode (such as, the second STA 404-b may change from operating in a power saving mode to operating in an active mode or a dynamic power saving mode).

The primary configuration of the AP 402 and the secondary configuration of the AP 402 may be related to various different AP configurations. For example, the primary configuration of the AP 402 and the secondary configuration of the AP 402 may each be associated with at least one of a first quantity of antennas and a second quantity of antennas, a first quantity of receiver front ends and a second quantity of receiver front ends, a first MCS and a second MCS, or a first encoder type and a second encoder type.

In some examples, the AP 402 may change at least the portion of second data from being associated with the primary configuration of the AP 402 to being associated with the secondary configuration of the AP 402 in accordance with receiving one or more polling messages from a quantity of STAs that includes at least the second STA 404-b. For example, the one or more polling messages may include a request that at least the portion of the second data changes from being associated with the secondary configuration of the AP 402 to being associated with the primary configuration of the AP 402. In some examples, the one or more polling messages may be a power saving polling frame, an APSD trigger, an initiating control frame, among other initiating frames.

In some aspects, the reactivity of the AP 402 to the one or more polling messages (such as a duration that elapses between the AP 402 receiving the one or more polling messages and the AP 402 transmitting data to the second STA 404-b) may be associated with the second data being associated with the secondary configuration of the AP 402 or being associated with the primary configuration of the AP 402 at a time that the AP 402 receives the one or more polling messages.

In some implementations, the AP 402 may communicate a first frame to initiate a service duration to communicate with the second STA 404-b (such as a downlink control frame, a APSD trigger frame, a QoS null frame). The AP 402 may transmit an indication of a duration for the AP 402 to change at least the portion of the second data associated with the second STA 404-b from being associated with the secondary configuration of the AP 402 to being associated with the primary configuration of the AP 402. After the duration elapses, the AP 402 may communicate at least the portion of the second data via a protected control frame to the second STA 404-b.

In some aspects, the indication of the duration for the AP 402 to change at least the portion of the second data associated with the second STA 404-b from being associated with the secondary configuration of the AP 402 to being associated with the primary configuration of the AP 402 also includes a request for the second STA 404-b to add padding to at least one subsequent message transmitted from the second STA 404-b to the AP 402.

In some examples, the AP 402 may change at least the portion of second data from being associated with the primary configuration of the AP 402 to being associated with the secondary configuration of the AP 402 in accordance with a traffic pattern that indicates that the second STA 404-b is operating in the first mode. For example, the AP 402 may change at least the portion of second data from being associated with the primary configuration of the AP 402 to being associated with the secondary configuration of the AP 402 prior to an occurrence of a wake interval associated with a TWT configuration associated with the second STA 404-b.

In some examples, the AP 402 may predict that the second STA 404-b will change from the second operating mode to the first operating mode (such as using machine learning techniques, AI models, traffic prediction techniques for the second STA 404-b, among other prediction techniques), and may change at least the portion of the second data from being associated with the secondary configuration of the AP 402 to being associated with the primary configuration of the AP 402 prior to the change in the operating mode of the second STA 404-b.

In some implementations, the AP 402 may transmit one or more messages to the second STA 404-b that indicate a duration that the AP 402 uses to change at least the portion of the second data from being associated with the secondary configuration of the AP 402 to being associated with the primary configuration of the AP 402. In some implementations, the AP 402 may transmit an indication that at least the portion of the second data is stored in accordance with the primary configuration of the AP 402 or the secondary configuration of the AP 402. For example, the AP 402 may transmit a TIM element that includes a TIM bit, and a first value of the TIM bit may indicate a first stored location of at least the portion of the second data and a second value of the TIM bit may indicate a second stored location of at least the portion of the second data. In such examples, a TIM bit having a “1” value may indicate that at least the portion of the second data is stored in accordance with the primary configuration of the AP 402, and a TIM bit having a “0” value may indicate that at least the portion of the second data is stored in accordance with the secondary configuration of the AP 402.

In some implementations, the AP 402 may store at least the portion of the second data in accordance with the secondary configuration of the AP 402 in accordance with a BSS load of the AP satisfying a BSS load threshold. For example, in implementations that the AP 402 may experience traffic from multiple STAs that exceeds the BSS load threshold, the AP 402 may operate in accordance with the second configuration of the AP 402. In some examples, the AP 402 may communicate a current BSS load to the second STA 404-b so that the second STA 404-b may implicitly determine that at least the portion of the second data is associated with the second configuration of the AP 402. Additionally, or alternatively, the AP 402 may communicate an indication of a quantity of STAs that the AP 402 is serving. The second STA 404-b may implicitly determine that at least the portion of the second data is associated with the secondary configuration of the AP 402 in examples in which the quantity of STAs exceeds a threshold quantity, or that at least the portion of the second data is associated with the primary configuration of the AP 402 in examples in which the quantity of STAs is less than the threshold quantity.

In some implementations, the AP 402 may receive, from the second STA 404-b, a request to trigger availability of at least the portion of second data at a primary configuration of another AP (different than the AP 402) of an AP MLD that includes at least the AP 402. For example, the second STA 404-b may request that the second data be available at another AP (such as an AP that the second STA 404-b will connect to at a future time). In some other implementations, the second STA 404-b may communicate one or more messages in accordance with a first MCS or bandwidth, and may communicate an additional one or more messages in accordance with a second MCS or bandwidth based on the AP 402 changing at least the portion of the second data from being associated with the secondary configuration of the AP 402 to being associated with the primary configuration of the AP 402.

In some implementations, the AP 402 may transmit one or more messages indicative of respective link statuses for at least a first link associated with the first STA 404-a and a second link associated with the second STA 404-b. In some examples, the respective link statuses may indicate an active link status associated with data associated with the primary configuration of the AP 402, or an idle link status associated with data associated with the secondary configuration of the AP 402. In some examples, the first STA 404-a and the second STA 404-b may determine whether data is associated with the primary configuration of the AP 402, or the secondary configuration of the AP 402 based on the link statuses.

At 410, the AP 402 may communicate at least the portion of the second data associated with the second STA 404-b in accordance with the AP 402 changing the portion of the second data from being associated with the secondary configuration of the AP 402 to being associated with the primary configuration of the AP 402 (and in accordance with the second STA 404-b operating in the first mode). In some examples, the first data, the second data, or both, include pending data addressed to the STA or include one or more configuration parameters that enable frame exchanges between the device and the STA.

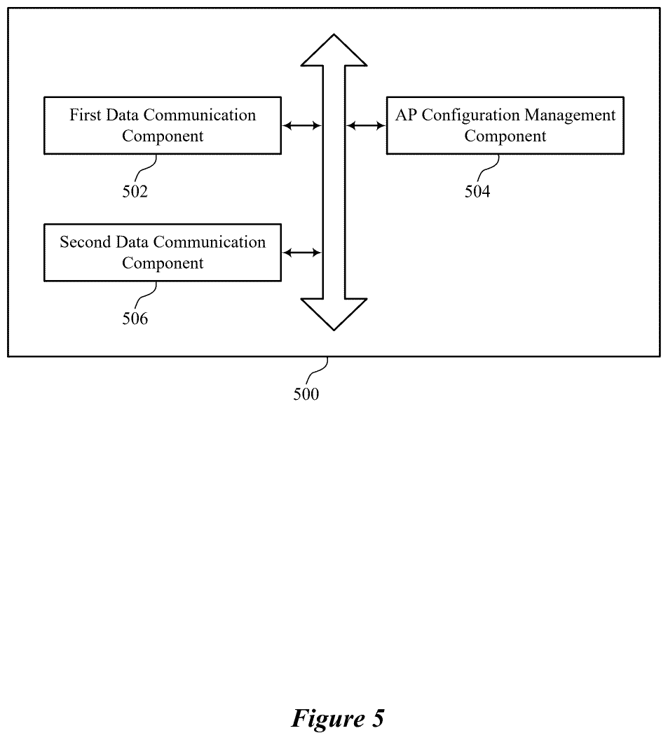

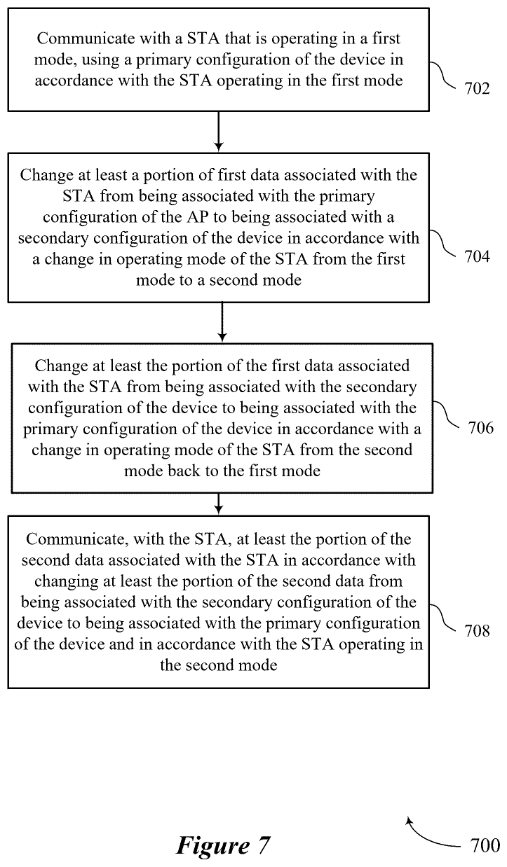

FIG. 5 shows a block diagram of an example wireless communication device 500 that supports device coordinated dynamic configuration management for high reliability communication. In some examples, the wireless communication device 500 is configured to perform the process 700 described with reference to FIG. 7. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an example, the second interface may refer to an interface between the processing system of the chip and a reception component, such that the wireless communication device 500 may receive information that is then passed to the processing system. In some such examples, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can be configurable or configured for use in an AP, such as the AP 102 described with reference to FIG. 1, or another device. In some other examples, the wireless communication device 500 can be an AP that includes such a processing system and other components including multiple antennas. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, the wireless communication device 500 further includes at least one external network interface coupled with the processing system that enables communication with a core network or backhaul network that enables the wireless communication device 500 to gain access to external networks including the Internet.

The wireless communication device 500 includes a first data communication component 502, an AP configuration management component 504, and a second data communication component 506. Portions of one or more of the first data communication component 502, the AP configuration management component 504, and the second data communication component 506 may be implemented at least in part in hardware or firmware. For example, one or more of the first data communication component 502, the AP configuration management component 504, and the second data communication component 506 may be implemented at least in part by at least a processor or a modem. In some examples, portions of one or more of the first data communication component 502, the AP configuration management component 504, and the second data communication component 506 may be implemented at least in part by a processor and software in the form of processor-executable code stored in memory.

The wireless communication device 500 may support wireless communication in accordance with examples as disclosed herein. The first data communication component 502 is configurable or configured to communicate with a STA that is operating in a first mode using a primary configuration of the AP in accordance with the STA operating in the first mode. The AP configuration management component 504 is configurable or configured to change at least a portion of first data associated with the STA from being associated with the primary configuration of the AP to being associated with a secondary configuration of the AP in accordance with a change in operating mode of the STA from the first mode to a second mode. The AP configuration management component 504 is configurable or configured to change at least the portion of the first data associated with the STA from being associated with the secondary configuration of the AP to being associated with the primary configuration of the AP in accordance with a change in operating mode of the STA from the second mode back to the first mode. The second data communication component 506 is configurable or configured to communicate, with the STA using the primary configuration of the AP in accordance with the changing of at least the portion of the first data from being associated with the secondary configuration of the AP to being associated with the primary configuration of the AP and in accordance with the STA operating in the first mode.

In some examples, the AP configuration management component 504 is configurable or configured to receive, from a quantity of STAs including at least the STA, one or more polling messages that request at least the portion of the first data and are indicative of the quantity of STAs operating in the first mode, where changing at least the portion of the first data associated with the STA from being associated with the secondary configuration of the AP to being associated with the primary configuration of the AP is in accordance with the quantity of STAs exceeding a threshold quantity.

In some examples, changing at least the portion of the first data associated with the STA from being associated with the secondary configuration of the AP back to being associated with the primary configuration of the AP is in accordance with a traffic pattern that indicates that the STA is operating in the first mode.

In some examples, changing at least the portion of the first data associated with the STA from being associated with the secondary configuration of the AP to being associated with the primary configuration of the AP occurs prior to an occurrence of a wake interval associated with a target wake time (TWT) configuration associated with the STA.

In some examples, the AP configuration management component 504 is configurable or configured to receive, from the STA, one or more polling messages indicative of the respective change in operating mode of the STA from the second mode back to the first mode, where changing at least a portion of the first data associated with the STA from being associated with the secondary configuration of the AP to being associated with the primary configuration of the AP is in accordance with receiving the one or more polling messages. In some examples, the one or more polling messages include one or more of a power saving polling frame, an automatic power save delivery trigger, or an initiating control frame. In some examples, a reactivity of the AP to the one or more polling messages is associated with the first data associated with the STA being associated with the secondary configuration of the AP or being associated with the primary configuration of the AP at a time that the AP receives the one or more polling messages.

In some examples, changing at least the portion of the first data associated with the STA from being associated with the secondary configuration of the AP to being associated with the primary configuration of the AP occurs prior to a predicted change in operating mode of the STA from the second mode back to the first mode, or in accordance with a predicted increase in traffic associated with the STA operating in the first mode.

In some examples, the AP configuration management component 504 is configurable or configured to obtain, using one or more artificial intelligence or machine learning models, the predicted change in operating mode of the STA, the predicted increase in traffic associated with the STA, or both.

In some examples, the AP configuration management component 504 is configurable or configured to transmit, to the STA, one or more messages indicative of a duration of time the AP uses to change at least the portion of the first data associated with the STA from being associated with the secondary configuration of the AP to being associated with the primary configuration of the AP.

In some examples, the AP configuration management component 504 is configurable or configured to transmit, to one or more associated STAs including at least the STA, an indication of a first stored location of at least the portion of the first data or a second stored location of at least the portion of the first data, the first stored location and the second stored location being associated with the primary configuration of the AP or the secondary configuration of the AP.

In some examples, the indication of the first stored location of at least the portion of the first data or the second stored location of at least the portion of the first data includes a TIM bit included in a TIM element, and a first value of the TIM bit is indicative of the first stored location of at least the portion of the first data or the second stored location of at least the portion of the first data being stored in accordance with the primary configuration of the AP. In some examples, the first value of the TIM bit is one.

In some examples, the AP configuration management component 504 is configurable or configured to communicate a first frame to initiate a service duration for communication of at least the portion of the first data between the AP and the STA, where changing at least the portion of the first data associated with the STA from being associated with the secondary configuration of the AP to being associated with the primary configuration of the AP includes transmitting, to the STA, an indication of a duration of time the AP uses to change at least the portion of the first data from being associated with the secondary configuration of the AP to being associated with the primary configuration of the AP, and communicating the portion of the first data includes communicating, via a protected control frame, at least the portion of the first data associated with the STA in accordance with initiation of the service duration and the STA operating in the first mode.

In some examples, the first frame to initiate the service duration between the AP and the STA is a downlink control frame associated with the STA generated by the AP, an unscheduled automatic power save delivery trigger frame received from the STA or a quality of service null frame received from the STA.

In some examples, the indication of the duration of time the AP uses to change at least the portion of the first data from being associated with the secondary configuration of the AP to being associated with the primary configuration of the AP includes a request for padding to be applied to messages communicated by the STA to the AP.

In some examples, the AP configuration management component 504 is configurable or configured to store at least the portion of the first data associated with the STA in accordance with the primary configuration of the AP and in accordance with the first mode of the STA including an active mode, and storing at least the portion of the first data in accordance with the secondary configuration of the AP and in accordance with the second mode of the STA including a power saving mode.

In some examples, the AP configuration management component 504 is configurable or configured to store at least the portion of the first data associated with the STA in accordance with the primary configuration of the AP in accordance with the first mode of the STA including an active mode, or in accordance with the secondary configuration of the AP in accordance with the second mode of the first STA including a power saving mode.

In some examples, the AP configuration management component 504 is configurable or configured to store at least the portion of the first data in accordance with the primary configuration of the AP in accordance with the first mode of the first STA or the second STA including a dynamic power saving mode.

In some examples, the AP configuration management component 504 is configurable or configured to store at least the portion of the first data in accordance with the secondary configuration of the AP in accordance with a BSS load of the AP satisfying a BSS load threshold, the BSS load being associated with at least the change in the operating mode of the STA from the second mode to the first mode. In some examples, the AP configuration management component 504 is configurable or configured to transmit, to the STA, the one or more messages indicative of the BSS load threshold.

In some examples, the AP configuration management component 504 is configurable or configured to store at least the portion of the first data in accordance with the secondary configuration of the AP in accordance with a quantity of STAs including the STA served by the AP satisfying a threshold. In some examples, the AP configuration management component 504 is configurable or configured to transmit, to the STA, one or more messages indicative quantity of STAs served by the AP.

In some examples, the AP configuration management component 504 is configurable or configured to receive, from the STA, a request to trigger availability of at least the portion of the first data in accordance with a primary configuration of another AP of an AP multi-link device (MLD) that includes at least the AP.

In some examples, the first mode is associated with a first modulation and coding scheme (MCS) and the second mode is associated with a second MCS, and the AP configuration management component 504 is configurable or configured to receive, from the STA, one or more messages in accordance with the first MCS, the one or more messages indicative of the second MCS associated with the STA, where at least the portion of the first data associated the second MCS is communicated with the STA in accordance with the second MCS.

In some examples, the first mode is associated with a first bandwidth and the second mode is associated with a second bandwidth, and the AP configuration management component 504 is configurable or configured to receive, from the STA, one or more messages in accordance with the first bandwidth, the one or more messages indicative of the second bandwidth associated with the STA, where at least the portion of the first data associated the second bandwidth is communicated with the STA in accordance with the second bandwidth.

In some examples, the AP configuration management component 504 is configurable or configured to transmit one or more messages indicative of a link status for at least a first link associated with the STA, the link status indicating an active link status associated with data associated with the primary configuration of the AP or an idle link status associated with data associated with the secondary configuration of the AP.

In some examples, the active link status is associated with link activity occurring within a BSS threshold time and the idle link status is associated with an absence of link activity occurring within the BSS threshold time.

In some examples, the primary configuration of the AP and the secondary configuration of the AP are each associated with at least one of a first quantity of antennas and a second quantity of antennas, a first quantity of receiver front ends and a second quantity of receiver front ends, a first modulation and coding scheme (MCS) and a second MCS, or a first encoder type and a second encoder type. In some examples,

In some examples, the first data includes pending data addressed to the STA or includes one or more configuration parameters that enable frame exchanges between the device and the STA. In some examples, the first mode includes an active mode, and the second mode includes a power saving mode.

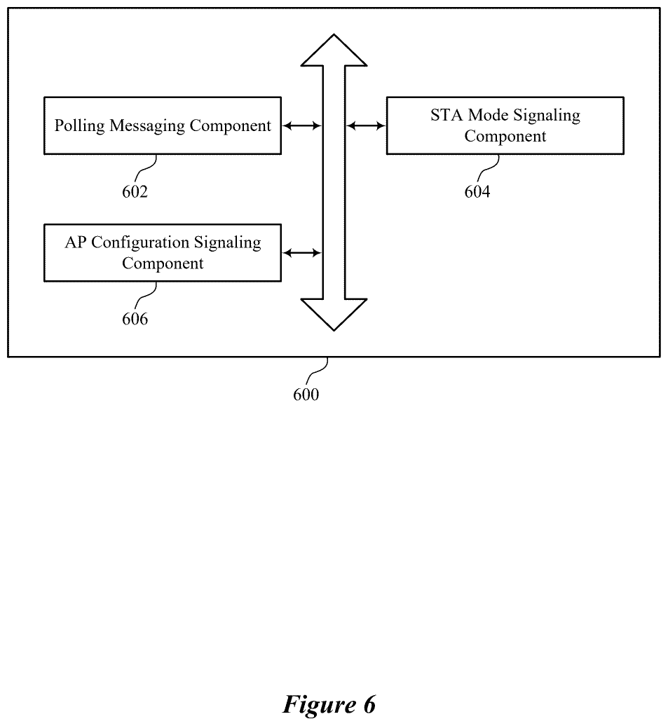

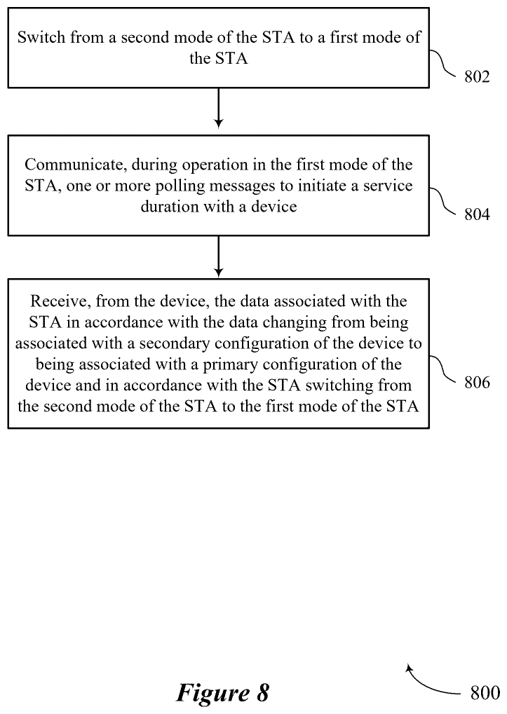

FIG. 6 shows a block diagram of an example wireless communication device 600 that supports device coordinated dynamic configuration management for high reliability communication. In some examples, the wireless communication device 600 is configured to perform the process 800 described with reference to FIG. 8. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is then passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in a STA, such as the STA 104 described with reference to FIG. 1. In some other examples, the wireless communication device 600 can be a STA that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes a user interface (UI) (such as a touchscreen or keypad) and a display, which may be integrated with the UI to form a touchscreen display that is coupled with the processing system. In some examples, the wireless communication device 600 may further include one or more sensors such as, for example, one or more inertial sensors, accelerometers, temperature sensors, pressure sensors, or altitude sensors, that are coupled with the processing system.

The wireless communication device 600 includes a polling messaging component 602, a STA mode signaling component 604, and an AP (or other device) configuration signaling component 606. Portions of one or more of the polling messaging component 602, the STA mode signaling component 604, and the AP configuration signaling component 606 may be implemented at least in part in hardware or firmware. For example, one or more of the polling messaging component 602, the STA mode signaling component 604, and the AP configuration signaling component 606 may be implemented at least in part by at least a processor or a modem. In some examples, portions of one or more of the polling messaging component 602, the STA mode signaling component 604, and the AP configuration signaling component 606 may be implemented at least in part by a processor and software in the form of processor-executable code stored in memory.

The wireless communication device 600 may support wireless communication in accordance with examples as disclosed herein. The polling messaging component 602 is configurable or configured to switch from a second mode of the STA to a first mode of the STA and communicate, during operation in the first mode of the STA, one or more polling messages to initiate a service duration with an AP. The AP configuration signaling component 606 is configurable or configured to receive, from the AP, data associated with the STA in accordance with the data changing from being associated with a secondary configuration of the AP (or the device) to being associated with a primary configuration of the AP and in accordance with the STA switching from the second mode of the STA to the first mode of the STA.

In some examples, the one or more polling messages are indicative of a change in operating mode of the STA from the second mode to the first mode. In some examples, the one or more polling messages include at least one of a power saving polling frame, an automatic power save delivery trigger, or an initiating control frame.

In some examples, the AP configuration signaling component 606 is configurable or configured to receive, from the AP, one or more messages indicative of a duration of time the AP uses to change the data from being associated with the primary configuration of the AP to being associated with the secondary configuration of the AP.

In some examples, the indication of the duration of time the AP uses change the data from being associated with the primary configuration of the AP to being associated with the secondary configuration of the AP includes a request for padding to be applied to messages communicated by the STA to the AP.

In some examples, the AP configuration signaling component 606 is configurable or configured to receive, from the AP, an indication of a first stored location of the data, the first stored location being associated with the primary configuration of the AP or the secondary configuration of the AP.

In some examples, the indication of the first stored location of the data includes a TIM bit included in a TIM element, and a first value of the TIM bit is indicative of the first stored location of the data being associated with the primary configuration of the AP. In some examples, the first value of the TIM bit is one.

In some examples, to support receiving the data associated with the STA, the polling messaging component 602 is configurable or configured to receive, via a protected control frame after a duration of time, the data associated with the STA in accordance with initiation of the service duration. In some examples, the one or more polling messages to initiate the service duration are one or more unscheduled automatic power save delivery trigger frames or one or more quality of service null frames. In some examples, the one or more polling messages to initiate the service duration are one or more downlink control frames received from the AP to initiate the service duration.

In some examples, the AP configuration signaling component 606 is configurable or configured to receive, from the AP, one or more messages indicative of a BSS load of the AP, the data being associated with the primary configuration of the AP in accordance with the BSS load being less than a BBS threshold and the data being associated with the secondary configuration of the AP in accordance with the BSS load being greater than the BSS load threshold, the BSS load being associated with at least the STA operating in the first mode.

In some examples, the AP configuration signaling component 606 is configurable or configured to receive, from the AP, one or more messages indicative of a quantity of STAs served by the AP including at least the STA, the data being associated with the primary configuration of the AP in accordance with the quantity of STAs being less than a threshold, and the data being associated with the secondary configuration of the AP in accordance with the quantity of STAs being greater than the threshold.

In some examples, the polling messaging component 602 is configurable or configured to transmit, to the AP, a request to trigger availability of the data associated with a primary configuration of another AP of an AP multi-link device (MLD) that includes at least the AP.

In some examples, the first mode includes a first modulation and coding scheme (MCS), and the STA mode signaling component 604 is configurable or configured to transmit, to the AP, one or more messages in accordance with the first MCS, the one or more messages indicative of a second MCS associated with the STA, where the data associated with the STA is data associated with the second MCS received from the AP in accordance with the second MCS.

In some examples, the first mode includes a first bandwidth and the second mode includes a second bandwidth, and the STA mode signaling component 604 is configurable or configured to transmit, to the AP, one or more messages in accordance with the first bandwidth, the one or more messages indicative of the second bandwidth associated with the STA, where the data associated with the STA is data associated with the second bandwidth received from the AP in accordance with the second bandwidth.

In some examples, the STA mode signaling component 604 is configurable or configured to receive a message indication of a link status for at least a first link associated with the STA, the link status indicating an active link status associated with the data being associated with the primary configuration of the AP or an idle link status associated with the data being associated with the secondary configuration of the AP.

In some examples, the primary configuration of the AP and the secondary configuration of the AP are each associated with a first quantity of antennas and a second quantity of antennas, a first quantity of receiver front ends and a second quantity of receiver front ends, a first modulation and coding scheme (MCS) and a second MCS, a first encoder type and a second encoder type, or any combination thereof.

In some examples, the first mode includes an active mode, and the second mode includes a power saving mode.

FIG. 7 shows a flowchart illustrating an example process 700 performable by or at an AP that supports device coordinated dynamic configuration management for high reliability communication. The operations of the process 700 may be implemented by an AP or its components as described herein. For example, the process 700 may be performed by a wireless communication device, such as the wireless communication device 500 described with reference to FIG. 5, operating as or within a wireless AP. In some examples, the process 700 may be performed by a wireless AP, such as one of the APs 102 described with reference to FIG. 1.

In some examples, in 702, the AP may communicate with a STA that is operating in a first mode using a primary configuration of the AP in accordance with the STA operating in the first mode. The operations of 702 may be performed in accordance with examples as disclosed herein. In some implementations, aspects of the operations of 702 may be performed by a first data communication component 502 as described with reference to FIG. 5.

In some examples, in 704, the AP may change at least a portion of first data associated with the STA from being associated with the primary configuration of the AP to being associated with a secondary configuration of the AP in accordance with a change in operating mode of the STA from the first mode to a second mode. The operations of 704 may be performed in accordance with examples as disclosed herein. In some implementations, aspects of the operations of 704 may be performed by an AP configuration management component 504 as described with reference to FIG. 5.

In some examples, in 706, the AP may change at least the portion of the first data associated with the STA from being associated with the secondary configuration of the AP to being associated with the primary configuration of the AP in accordance with a change in operating mode of the STA from the second mode back to the first mode. The operations of 706 may be performed in accordance with examples as disclosed herein. In some implementations, aspects of the operations of 706 may be performed by a second data communication component 506 as described with reference to FIG. 5.

In some examples, in 708, the AP may communicate, with the STA using the primary configuration of the AP in accordance with the changing of at least the portion of the first data from being associated with the secondary configuration of the AP to being associated with the primary configuration of the AP and in accordance with the STA operating in the first mode. The operations of 708 may be performed in accordance with examples as disclosed herein. In some implementations, aspects of the operations of 708 may be performed by a second data communication component 506 as described with reference to FIG. 5.

FIG. 8 shows a flowchart illustrating an example process 800 performable by or at a STA that supports device coordinated dynamic configuration management for high reliability communication. The operations of the process 800 may be implemented by a STA or its components as described herein. For example, the process 800 may be performed by a wireless communication device, such as the wireless communication device 600 described with reference to FIG. 6, operating as or within a wireless STA. In some examples, the process 800 may be performed by a wireless STA, such as one of the STAs 104 described with reference to FIG. 1.

In some examples, in 802, the STA may switch from a second mode of the STA to a first mode of the STA. The operations of 802 may be performed in accordance with examples as disclosed herein. In some implementations, aspects of the operations of 802 may be performed by a STA mode signaling component 604 as described with reference to FIG. 6.

In some examples, in 804, the STA may communicate, during operation in the first mode of the STA, one or more polling messages to initiate a service duration with an AP. The operations of 804 may be performed in accordance with examples as disclosed herein. In some implementations, aspects of the operations of 804 may be performed by a polling messaging component 602 as described with reference to FIG. 6.

In some examples, in 804, the STA may receive, from the AP, data associated with the STA in accordance with the data changing from being associated with a secondary configuration of the AP to being associated with a primary configuration of the AP and in accordance with the STA switching from the second mode of the STA to the first mode of the STA. The operations of 806 may be performed in accordance with examples as disclosed herein. In some implementations, aspects of the operations of 806 may be performed by an AP configuration signaling component 606 as described with reference to FIG. 6.

Implementation examples are described in the following numbered clauses:

Clause 1: A method for wireless communications at a device, comprising: communicating with a STA that is operating in a first mode, using a primary configuration of the device in accordance with the STA operating in the first mode; changing at least a portion of first data associated with the STA from being associated with the primary configuration of the device to being associated with a secondary configuration of the device in accordance with a change in operating mode of the STA from the first mode to a second mode; changing at least the portion of the first data associated with the STA from being associated with the secondary configuration of the device to being associated with the primary configuration of the device in accordance with a change in operating mode of the STA from the second mode back to the first mode; and communicating with the STA using the primary configuration of the device in accordance with the changing of at least the portion of the first data from being associated with the secondary configuration of the device to being associated with the primary configuration of the device and in accordance with the STA operating in the first mode.

Clause 2: The method of clause 1, further comprising: receiving, from a quantity of STAs including at least the STA, one or more polling messages that request at least the portion of the first data and are indicative of the quantity of STAs operating in the first mode, wherein changing at least the portion of the first data associated with the STA from being associated with the secondary configuration of the device to being associated with the primary configuration of the device is in accordance with the quantity of STAs exceeding a threshold quantity.

Clause 3: The method of any of clauses 1-2, wherein changing at least the portion of the first data associated with the STA from being associated with the secondary configuration of the device to being associated with the primary configuration of the device is in accordance with a traffic pattern that indicates that the STA is operating in the first mode.

Clause 4: The method of any of clauses 1-3, wherein changing at least the portion of the first data associated with the STA from being associated with the secondary configuration of the device to being associated with the primary configuration of the device occurs prior to an occurrence of a wake interval associated with a target wake time (TWT) configuration associated with the STA.

Clause 5: The method of any of clauses 1-4, further comprising: receiving, from the STA, one or more polling messages indicative of the change in operating mode of the STA from the second mode back to the first mode, wherein changing at least a portion of the first data associated with the STA from being associated with the secondary configuration of the device to being associated with the primary configuration of the device is in accordance with receiving the one or more polling messages.

Clause 6: The method of clause 5, wherein a reactivity of the device to the one or more polling messages is associated with the first data associated with the STA being associated with the secondary configuration of the device or being associated with the primary configuration of the device at a time that the device receives the one or more polling messages.

Clause 7: The method of any of clauses 1-6, wherein changing at least the portion of the first data associated with the STA from being associated with the secondary configuration of the device to being associated with the primary configuration of the device occurs prior to a predicted change in operating mode of the STA from the second mode to the first mode, or in accordance with a predicted increase in traffic associated with the STA operating in the first mode.

Clause 8: The method of clause 7, further comprising: obtaining, using one or more artificial intelligence or machine learning models, the predicted change in operating mode of the STA, the predicted increase in traffic associated with the STA, or both.

Clause 9: The method of any of clauses 1-8, further comprising: transmitting, to the STA, one or more messages indicative of a duration of time the device uses to change at least the portion of the first data associated with the STA from being associated with the secondary configuration of the device to being associated with the primary configuration of the device.

Clause 10: The method of any of clauses 1-9, further comprising: transmitting, to one or more associated STAs including at least the STA, an indication of a first stored location of at least the portion of the first data or a second stored location of at least the portion of the first data, the first stored location and the second stored location being associated with the primary configuration of the device or the secondary configuration of the device.

Clause 11: The method of clause 10, wherein the indication of the first stored location of at least the portion of the first data or the second stored location of at least the portion of the first data comprises a traffic indication map (TIM) bit included in a TIM element, and a first value of the TIM bit equal to one is indicative of the first stored location of at least the portion of the first data or the second stored location of at least the portion of the first data being stored in accordance with the primary configuration of the device.

Clause 12: The method of any of clauses 1-11, further comprising: communicating a first frame to initiate a service duration for communication of at least the portion of the first data between the device and the STA, wherein changing at least the portion of the first data associated with the STA from being associated with the secondary configuration of the device to being associated with the primary configuration of the device comprises transmitting, to the STA, an indication of a duration of time the device uses to change at least the portion of the first data from being associated with the secondary configuration of the device to being associated with the primary configuration of the device, and communicating the portion of the first data comprises communicating, via a protected control frame, at least the portion of the first data associated with the STA in accordance with initiation of the service duration and the STA operating in the first mode.

Clause 13: The method of clause 12, wherein the first frame to initiate the service duration between the device and the STA is a downlink control frame associated with the STA generated by the device, an unscheduled automatic power save delivery trigger frame received from the STA or a quality of service null frame received from the STA.

Clause 14: The method of any of clauses 12-13, wherein the indication of the duration of time the device uses to change at least the portion of the first data from being associated with the secondary configuration of the device to being associated with the primary configuration of the device comprises a request for padding to be applied to messages communicated by the STA to the device.

Clause 15: The method of any of clauses 1-14, further comprising: storing at least the portion of the first data associated with the STA in accordance with the primary configuration of the device in accordance with the first mode of the STA comprising an active mode, or in accordance with the secondary configuration of the device in accordance with the second mode of the STA comprising a power saving mode.

Clause 16: The method of any of clauses 1-15, further comprising: storing at least the portion of the first data associated with the STA in accordance with the primary configuration of the device in accordance with the first mode of the STA comprising a dynamic power saving mode.

Clause 17: The method of any of clauses 1-16, further comprising: storing at least the portion of the first data in accordance with the secondary configuration of the device in accordance with a basic service set (BSS) load of the device satisfying a BSS load threshold, the BSS load being associated with at least the change in the operating mode of the STA from the first mode to a second mode; and transmitting, to the STA, one or more messages indicative of the BSS load threshold.

Clause 18: The method of any of clauses 1-17, further comprising: storing at least the portion of the first data in accordance with the secondary configuration of the device in accordance with a quantity of STAs including at least the STA served by the device satisfying a threshold; and transmitting, to the STA, one or more messages indicative of the quantity of STAs served by the device.

Clause 19: The method of any of clauses 1-18, further comprising: receiving, from the STA, a request to trigger availability of at least the portion of the first data in accordance with a primary configuration of another device of an AP multi-link device (MLD) that includes at least the device.

Clause 20: The method of any of clauses 1-19, wherein the first mode is associated with a first modulation and coding scheme (MCS) and the second mode is associated with a second MCS, the method further comprising: receiving, from the STA, one or more messages in accordance with the first MCS, the one or more messages indicative of the second MCS associated with the STA, wherein at least the portion of the first data associated the second MCS is communicated with the STA in accordance with the second MCS.

Clause 21: The method of any of clauses 1-20, wherein the first mode is associated with a first bandwidth and the second mode is associated with a second bandwidth, the method further comprising: receiving, from the STA, one or more messages in accordance with the first bandwidth, the one or more messages indicative of the second bandwidth associated with the STA, wherein at least the portion of the first data associated the second bandwidth is communicated with the STA in accordance with the second bandwidth.

Clause 22: The method of any of clauses 1-21, further comprising: transmitting one or more messages indicative of a link status for at least a first link associated with the STA, the link status indicating an active link status associated with data associated with the primary configuration of the device or an idle link status associated with data associated with the secondary configuration of the device.

Clause 23: The method of any of clauses 1-22, wherein the first data comprises pending data addressed to the STA or comprises one or more configuration parameters that enable frame exchanges between the device and the STA.

Clause 24: The method of any of clauses 1-23, wherein the primary configuration of the device and the secondary configuration of the device are each associated with at least one of a first quantity of antennas and a second quantity of antennas, a first quantity of receiver front ends and a second quantity of receiver front ends, a first modulation and coding scheme (MCS) and a second MCS, a first CPU configuration and a second CPU configuration, or a first encoder type and a second encoder type.

Clause 25: A method for wireless communications at a STA, comprising: switching from a second mode of the STA to a first mode of the STA; communicating, during operation in the first mode of the STA, one or more polling messages to initiate a service duration with a device; and receiving, from the device, data associated with the STA in accordance with the data changing from being associated with a secondary configuration of the device to being associated with a primary configuration of the device and in accordance with the STA switching from the second mode of the STA to the first mode of the STA.

Clause 26: The method of clause 25, further comprising: receiving, from the device, one or more messages indicative of a duration of time the device uses to change the data from being associated with the primary configuration of the device to being associated with the secondary configuration of the device, wherein the duration of time the device uses change the data from being associated with the primary configuration of the device to being associated with the secondary configuration of the device comprises a request for padding to be applied to messages communicated by the STA to the device.

Clause 27: The method of any of clauses 25-26, further comprising: receiving, from the device, an indication of a first stored location of the data, the first stored location being associated with the primary configuration of the device or the secondary configuration of the device.

Clause 28: The method of any of clauses 25-27, further comprising: receiving a message indication of a link status for at least a first link associated with the STA, the link status indicating an active link status associated with the data being associated with the primary configuration of the device or an idle link status associated with the data being associated with the secondary configuration of the device.

Clause 29: A device for wireless communication, including a processing system that includes processor circuitry and memory circuitry that stores code, the processing system configured to cause the device to perform a method of any of clauses 1-24.

Clause 30: A device for wireless communication, comprising at least one means for performing a method of any of clauses 1-24.

Clause 31: A non-transitory computer-readable medium storing code for wireless communication, the code including instructions executable by a processing system (such as one or more processors) to perform a method of any of clauses 1-24.

Clause 32: A STA for wireless communications, comprising including a processing system that includes processor circuitry and memory circuitry that stores code, the processing system configured to cause the STA to perform a method of any of clauses 25-28.

Clause 33: A STA for wireless communication, comprising at least one means for performing a method of any of clauses 25-28.

Clause 34: A non-transitory computer-readable medium storing code for wireless communication, the code including instructions executable by a processing system (such as one or more processors) to perform a method of any of clauses 25-28.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A device, comprising:
a processing system that includes processor circuitry and memory circuitry that stores code, the processing system configured to cause the device to:
communicate with a station (STA) that is operating in a first mode, using a primary configuration of the device in accordance with the STA operating in the first mode;
change at least a portion of first data associated with the STA from being associated with the primary configuration of the device to being associated with a secondary configuration of the device in accordance with a change in operating mode of the STA from the first mode to a second mode;
change at least the portion of the first data associated with the STA from being associated with the secondary configuration of the device to being associated with the primary configuration of the device in accordance with a change in operating mode of the STA from the second mode back to the first mode; and
communicate with the STA using the primary configuration of the device in accordance with the changing of at least the portion of the first data from being associated with the secondary configuration of the device to being associated with the primary configuration of the device and in accordance with the STA operating in the first mode.

2. The device of claim 1, wherein the processing system is further configured to cause the device to:
receive, from a quantity of STAs including at least the STA, one or more polling messages that request at least the portion of the first data and are indicative of the quantity of STAs operating in the first mode, wherein changing at least the portion of the first data associated with the STA from being associated with the secondary configuration of the device to being associated with the primary configuration of the device is in accordance with the quantity of STAs exceeding a threshold quantity.

3. The device of claim 1, wherein changing at least the portion of the first data associated with the STA from being associated with the secondary configuration of the device to being associated with the primary configuration of the device is in accordance with a traffic pattern that indicates that the STA is operating in the first mode.

4. The device of claim 1, wherein changing at least the portion of the first data associated with the STA from being associated with the secondary configuration of the device to being associated with the primary configuration of the device occurs prior to an occurrence of a wake interval associated with a target wake time (TWT) configuration associated with the STA.

5. The device of claim 1, wherein the processing system is further configured to cause the device to:
receive, from the STA, one or more polling messages indicative of the change in operating mode of the STA from the second mode back to the first mode, wherein changing at least a portion of the first data associated with the STA from being associated with the secondary configuration of the device to being associated with the primary configuration of the device is in accordance with receiving the one or more polling messages.

6. The device of claim 5, wherein a reactivity of the device to the one or more polling messages is associated with the first data associated with the STA being associated with the secondary configuration of the device or being associated with the primary configuration of the device at a time that the device receives the one or more polling messages.

7. The device of claim 1, wherein changing at least the portion of the first data associated with the STA from being associated with the secondary configuration of the device to being associated with the primary configuration of the device occurs prior to a predicted change in operating mode of the STA from the second mode to the first mode, or in accordance with a predicted increase in traffic associated with the STA operating in the first mode.

8. The device of claim 7, wherein the processing system is further configured to cause the device to:
obtain, using one or more artificial intelligence or machine learning models, the predicted change in operating mode of the STA, the predicted increase in traffic associated with the STA, or both.

9. The device of claim 1, wherein the processing system is further configured to cause the device to:
transmit, to the STA, one or more messages indicative of a duration of time the device uses to change at least the portion of the first data associated with the STA from being associated with the secondary configuration of the device to being associated with the primary configuration of the device.

10. The device of claim 1, wherein the processing system is further configured to cause the device to:
transmit, to one or more associated STAs including at least the STA, an indication of a first stored location of at least the portion of the first data or a second stored location of at least the portion of the first data, the first stored location and the second stored location being associated with the primary configuration of the device or the secondary configuration of the device.

11. The device of claim 10, wherein the indication of the first stored location of at least the portion of the first data or the second stored location of at least the portion of the first data comprises a traffic indication map (TIM) bit included in a TIM element, and a first value of the TIM bit equal to one is indicative of the first stored location of at least the portion of the first data or the second stored location of at least the portion of the first data being stored in accordance with the primary configuration of the device.

12. The device of claim 1, wherein the processing system is further configured to cause the device to:
communicate a first frame to initiate a service duration for communication of at least the portion of the first data between the device and the STA, wherein changing at least the portion of the first data associated with the STA from being associated with the secondary configuration of the device to being associated with the primary configuration of the device comprises transmitting, to the STA, an indication of a duration of time the device uses to change at least the portion of the first data from being associated with the secondary configuration of the device to being associated with the primary configuration of the device, and communicating the portion of the first data comprises communicating, via a protected control frame, at least the portion of the first data associated with the STA in accordance with initiation of the service duration and the STA operating in the first mode.

13. The device of claim 12, wherein the first frame to initiate the service duration between the device and the STA is a downlink control frame associated with the STA generated by the device, an unscheduled automatic power save delivery trigger frame received from the STA or a quality of service null frame received from the STA.

14. The device of claim 12, wherein the indication of the duration of time the device uses to change at least the portion of the first data from being associated with the secondary configuration of the device to being associated with the primary configuration of the device comprises a request for padding to be applied to messages communicated by the STA to the device.

15. The device of claim 1, wherein the processing system is further configured to cause the device to:
store at least the portion of the first data associated with the STA in accordance with the primary configuration of the device in accordance with the first mode of the STA comprising an active mode, or in accordance with the secondary configuration of the device in accordance with the second mode of the STA comprising a power saving mode.

16. The device of claim 1, wherein the processing system is further configured to cause the device to:
store at least the portion of the first data associated with the STA in accordance with the primary configuration of the device in accordance with the first mode of the STA comprising a dynamic power saving mode.

17. The device of claim 1, wherein the processing system is further configured to cause the device to:
store at least the portion of the first data in accordance with the secondary configuration of the device in accordance with a basic service set (BSS) load of the device satisfying a BSS load threshold, the BSS load being associated with at least the change in the operating mode of the STA from the first mode to a second mode; and
transmit, to the STA, one or more messages indicative of the BSS load threshold.

18. The device of claim 1, wherein the processing system is further configured to cause the device to:
store at least the portion of the first data in accordance with the secondary configuration of the device in accordance with a quantity of STAs including at least the STA served by the device satisfying a threshold; and
transmit, to the STA, one or more messages indicative of the quantity of STAs served by the device.

19. The device of claim 1, wherein the processing system is further configured to cause the device to:
receive, from the STA, a request to trigger availability of at least the portion of the first data in accordance with a primary configuration of another device of an AP multi-link device (MLD) that includes at least the device.

20. The device of claim 1, wherein the first mode is associated with a first modulation and coding scheme (MCS) and the second mode is associated with a second MCS, and the processing system is further configured to cause the device to:
receive, from the STA, one or more messages in accordance with the first MCS, the one or more messages indicative of the second MCS associated with the STA, wherein at least the portion of the first data associated the second MCS is communicated with the STA in accordance with the second MCS.

21. The device of claim 1, wherein the first mode is associated with a first bandwidth and the second mode is associated with a second bandwidth, and the processing system is further configured to cause the device to:
receive, from the STA, one or more messages in accordance with the first bandwidth, the one or more messages indicative of the second bandwidth associated with the STA, wherein at least the portion of the first data associated the second bandwidth is communicated with the STA in accordance with the second bandwidth.

22. The device of claim 1, wherein the processing system is further configured to cause the device to:
transmit one or more messages indicative of a link status for at least a first link associated with the STA, the link status indicating an active link status associated with data associated with the primary configuration of the device or an idle link status associated with data associated with the secondary configuration of the device.

23. The device of claim 1, wherein the first data comprises pending data addressed to the STA or comprises one or more configuration parameters that enable frame exchanges between the device and the STA.

24. The device of claim 1, wherein the primary configuration of the device and the secondary configuration of the device are each associated with at least one of a first quantity of antennas and a second quantity of antennas, a first quantity of receiver front ends and a second quantity of receiver front ends, a first modulation and coding scheme (MCS) and a second MCS, a first central processing unit (CPU) configuration and a second CPU configuration, or a first encoder type and a second encoder type.

25. A station (STA), comprising:
a processing system that includes processor circuitry and memory circuitry that stores code, the processing system configured to cause the STA to:
switch from a second mode of the STA to a first mode of the STA;
communicate, during operation in the first mode of the STA, one or more polling messages to initiate a service duration with a device; and
receive, from the device, data associated with the STA in accordance with the data changing from being associated with a secondary configuration of the device to being associated with a primary configuration of the device and in accordance with the STA switching from the second mode of the STA to the first mode of the STA.

26. The STA of claim 25, wherein the processing system is further configured to cause the STA to:
receive, from the device, one or more messages indicative of a duration of time the device uses to change the data from being associated with the primary configuration of the device to being associated with the secondary configuration of the device, wherein the duration of time the device uses change the data from being associated with the primary configuration of the device to being associated with the secondary configuration of the device comprises a request for padding to be applied to messages communicated by the STA to the device.

27. The STA of claim 25, wherein the processing system is further configured to cause the STA to:
receive, from the device, an indication of a first stored location of the data, the first stored location being associated with the primary configuration of the device or the secondary configuration of the device.

28. The STA of claim 25, wherein the processing system is further configured to cause the STA to:
receive a message indication of a link status for at least a first link associated with the STA, the link status indicating an active link status associated with the data being associated with the primary configuration of the device or an idle link status associated with the data being associated with the secondary configuration of the device.

29. A method for wireless communication by a device, comprising:
communicating with a station (STA) that is operating in a first mode using a primary configuration of the device in accordance with the STA operating in the first mode;
changing at least a portion of first data associated with the STA from being associated with the primary configuration of the device to being associated with a secondary configuration of the device in accordance with a change in operating mode of the STA from the first mode to a second mode;
change at least the portion of the first data associated with the STA from being associated with the secondary configuration of the device to being associated with the primary configuration of the device in accordance with a change in operating mode of the STA from the second mode back to the first mode; and
communicating, with the STA using the primary configuration of the device in accordance with the changing of at least the portion of the first data from being associated with the secondary configuration of the device to being associated with the primary configuration of the device and in accordance with the STA operating in the first mode.

30. A method for wireless communication by a station (STA), comprising:
switching from a second mode of the STA to a first mode of the STA;
communicating, during operation in the first mode of the STA, one or more polling messages to initiate a service duration with a device; and
receiving, from the device, data associated with the STA in accordance with the data changing from being associated with a secondary configuration of the device to being associated with a primary configuration of the device and in accordance with the STA switching from the second mode of the STA to the first mode of the STA.
